(19) United States
(12) Patent Application Publication
(10) Pub. No.: US 2025/0103358 A1
(43) Pub. Date: Mar. 27, 2025

(54) OBJECT PROCESSING METHOD, ELECTRONIC DEVICE, AND MEDIUM

(71) Applicant: Beijing Zitiao Network Technology Co., Ltd., Haidian District, Beijing (CN)

(72) Inventor: Wei LI, Beijing (CN)

(21) Appl. No.: 18/730,742

(22) PCT Filed: Jan. 5, 2023
(86) PCT No.: PCT/CN2023/070748

§ 371 Date: Jul. 19, 2024

(30) Foreign Application Priority Data
Jan. 21, 2022 (CN) 202210073768.6

(51) Int. Cl. G06F 9/451

(52) U.S. Cl. CPC G06F 9/451

(57) ABSTRACT

An object processing method, an electronic device and a medium are provided. The method is applied to an application and includes: displaying a processing interface, a number of objects to be processed in the processing interface being increased at a set speed; in response to determining that a target object is matched through the processing interface, displaying a marker of the target object in a target region in the processing interface, the number of the objects to be processed being increased at an adjusted set speed; and in response to determining that the number of the objects to be processed in the processing interface reaches a target value, processing the objects to be processed.

The present application claims priority of the Chinese Patent Application No. 202210073768.6, filed on Jan. 21, 2022, the entire disclosure of which is incorporated herein by reference as part of the present application.

### TECHNICAL FIELD

Embodiments of the present disclosure relate to the technical field of the internet, and for example, to an object processing method and apparatus, an electronic device, and a medium.

### BACKGROUND

In the virtual world of the network, different types of applications have different to-be-processed objects. The to-be-processed object in the application may be a virtual resource existing in the network, and a user can carry out processing on the to-be-processed object so as to implement transfer of the virtual resource.

In the related technical solution of carrying out processing on the to-be-processed object, a processing mode for the to-be-processed object is single, and the user has poor interaction experience in the process of processing the to-be-processed object.

### SUMMARY

Embodiments of the present disclosure provide an object processing method and apparatus, an electronic device, and a medium, so that the means of processing the objects to be processed is diversified and the visual interaction experience of the user is promoted.

In a first aspect, an embodiment of the present disclosure provides an object processing method, and the method includes:
displaying a processing interface, wherein a number of objects to be processed in the processing interface is increased at a set speed and the processing interface comprises at least one display region;
in response to determining that a target object is matched through the processing interface, displaying a marker of the target object in a target region in the processing interface, the number of the objects to be processed being increased at an adjusted set speed, wherein the adjusted set speed is determined based on the set speed and a level of the marker of the target object, the target region is an idle region in the display region, where no marker is displayed, and the idle region in the display region is displayed in the processing interface; and
in response to determining that the number of the objects to be processed in the processing interface reaches a target value, processing the objects to be processed.

In a second aspect, an embodiment of the present disclosure further provides an object processing apparatus, and the apparatus includes:
an interface display module, configured to display a processing interface, where a number of objects to be processed in the processing interface is increased at a set speed and the processing interface comprises at least one display region;
a marker display module, configured to, in response to determining that a target object is matched through the processing interface, display a marker of the target object in a target region in the processing interface, and increase the number of the objects to be processed at an adjusted set speed, wherein the adjusted set speed is determined based on the set speed and a level of the marker of the target object, the target region is an idle region in the display region, where no marker is displayed, and the idle region in the display region is displayed in the processing interface; and
a transfer module, configured to in response to determining that the number of the objects to be processed in the processing interface reaches a target value, process the objects to be processed.

In a third aspect, an embodiment of the present disclosure further provides an electronic device, and the electronic device includes:
one or more processors;
a storage apparatus, configured to store one or more programs,
where the one or more programs are executed by the one or more processors, causing the one or more processors to implement the object processing method provided by embodiments of the present disclosure.

In a forth aspect, an embodiment of the present disclosure further provides a computer-readable medium storing computer programs, and the computer programs upon being executed by a processor, implement the object processing method provided by embodiments of the present disclosure.

### BRIEF DESCRIPTION OF DRAWINGS

In the drawings throughout, same or similar drawing reference signs represent same or similar elements. It should be understood that the drawings are schematic, and originals and elements may not necessarily be drawn to scale.

FIG. 1 is a flow schematic diagram of an object processing method provided by an embodiment of the present disclosure;

FIG. 2 is an interface schematic diagram of a processing interface provided by an embodiment of the present disclosure;

FIG. 3 is an interface schematic diagram of a processing interface provided by another embodiment of the present disclosure;

FIG. 4 is a schematic diagram of a variation of the number of objects to be processed in a processing interface provided by an embodiment of the present disclosure;

FIG. 5 is a schematic diagram of a variation of matching a target object in a processing interface provided by an embodiment of the present disclosure;

FIG. 6 is a flow schematic diagram of an object processing method provided by another embodiment of the present disclosure;

FIG. 7 is a structural schematic diagram of an object processing apparatus provided by an embodiment of the present disclosure;

FIG. 8 is a structural schematic diagram of an electronic device provided by an embodiment of the present disclosure.

### DETAILED DESCRIPTION

It should be understood that a plurality of steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise stated in the context, it should be understood as “one or more”.

Names of messages or information exchanged between a plurality of apparatuses in embodiments of the present disclosure are only used for the purpose of description and not meant to limit the scope of these messages or information.

Both of example features and example embodiments are provided in the embodiments as will be described below. A plurality of features described in the embodiments may be combined to form a plurality of example solutions. Each numbered embodiment shall not be merely considered as a technical solution.

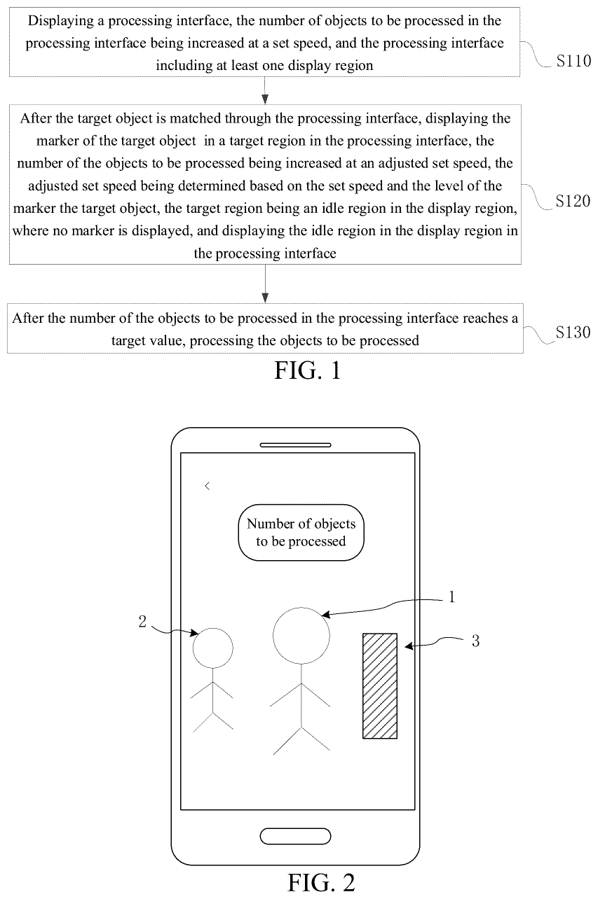

FIG. 1 is a flow schematic diagram of an object processing method provided by an embodiment of the present disclosure. The method is applicable to a case of processing an object. The method may be performed by an object processing apparatus, the apparatus may be implemented by software and/or hardware and generally is integrated on an electronic device, and in this embodiment, the electronic device includes, but is not limited to: devices such as a computer, a notebook computer, a tablet computer, a mobile phone, etc.

As shown in FIG. 1, an object processing method provided by an embodiment of the present disclosure includes the following steps:

At S110, a processing interface is displayed, the number of objects to be processed in the processing interface is increased at a set speed, and the processing interface includes at least one display region.

In this embodiment, the processing interface may refer to an interface for processing the objects to be processed, the object to be processed may refer to an object to be processed in an application. Exemplarily, the object to be processed may be a virtual resource.

In the process that a user carries out processing on the objects to be processed, a marker of the user may be displayed in the processing interface, the marker may be a virtual image which marks a processing progress when the user carries out processing on the objects to be processed, e.g., a little tiger or a virtual image set by the user, etc.

A plurality of levels may be set for the marker, and with the deepening of the processing progress when the user carries out processing on the objects to be processed, the level of the marker is also increased accordingly. Different levels may correspond to different markers, and different markers may be distinguished by different images or distinguished by different clothes. The position of the marker in the processing interface is not limited, and for example, may be an intermediate region of the processing interface, etc.; and the corresponding marker of each user may be the same or may be different.

A state of the object to be processed in the processing interface is not limited. Exemplarily, the object to be processed may be displayed in the processing interface in a static state, or may be displayed in the processing interface in a dynamic form, and for example, the hand or the body of the corresponding marker of the object to be processed may continuously shake so as to prompt the user to match with a target object in the processing interface.

It should be illustrated that different objects to be processed have different display forms in the processing interface. By taking a case that the object to be processed is a virtual resource as an example, the object to be processed may be displayed in a digital form in the processing interface or may be displayed in a graphic form in the processing interface. The virtual resource for example may be a credit, a gold coin, a red packet, etc. The set speed may refer to an increased speed of the object to be processed, this embodiment does not make any limit to the set speed, and for example, the set speed may be a constant speed value preset by a system or may be a speed after the object to be processed is processed.

In an embodiment, the processing interface may be displayed, the number of the objects to be processed in the processing interface may be increased at the set speed, and for example, may be continuously increased at the set speed all the time during the period when the application is started or opened, or may also be continuously increased at the set speed when the application is closed.

In an embodiment, at least one display region is included in the processing interface, the display region may be a partial region in the processing interface and can be used for placing a marker of the target object. The number of the display region is not limited and may be one or more.

It should be understood that the processing interface may include the corresponding marker of the user therein, or may include the marker of the target object, and the number of the marker of the target object is not limited and may be one or more; and the position of the marker of the target object in the processing interface is not limited, and for example, the marker of the target object may be positioned on the left side and/or the right side of a corresponding marker of the object to be processed. The target objects may be other users who process the object to be processed, the object to be processed by each user is independent, i.e., the user respectively processes the respective object to be processed, and the other users may be friends on an application used when the user processes the object to be processed and/or other applications, or may be friends who are not added nearby.

A function description control may also be included in the processing interface, and after the function description control is triggered, a function description interface may be displayed, and description of processing the object to be processed may be included in the function description interface.

In an embodiment, the marker of the user is displayed in the processing interface, a level of the marker of the user is increased with the increase of a completion degree of processing the object to be processed, the level of the marker of the target object is increased with the increase of a completion degree of processing a corresponding object to be processed by the target object, and markers of different levels have different clothes.

It should be understood that the marker of the user is displayed in the processing interface, the level of the marker of the user can be increased with the increase of the completion degree of processing the object to be processed; meanwhile, the marker of the target object is displayed in the processing interface, and the level of the marker of the target object may also be increased with the increase of the completion degree of processing the corresponding object to be processed by the target object; and in this embodiment, the specific step of increasing the level is not limited. The completion degree may be a depth degree of processing the object to be processed. By taking a case that the number of the objects to be processed is 100 as an example, when the number of the objects to be processed reaches 100, the objects to be processed may be processed. The completion degree when the number of the objects to be processed is 50 is greater than that when the number of the objects to be processed is 30. The completion degree may be determined by the number of the objects to be processed.

In addition, it should be illustrated that markers of different levels have different clothes, the levels of the markers are distinguished based on different clothes, and clothes may be Chinese style clothes, or may include accessories.

FIG. 2 is an interface schematic diagram of a processing interface provided by an embodiment of the present disclosure. As shown in FIG. 2, a marker 1 of a user, a marker 2 of a target object, and an idle region 3 are displayed in the processing interface. The shape of the idle region 3 is not limited, may be a random shape, and for example, a shape identical to the shape of the marker.

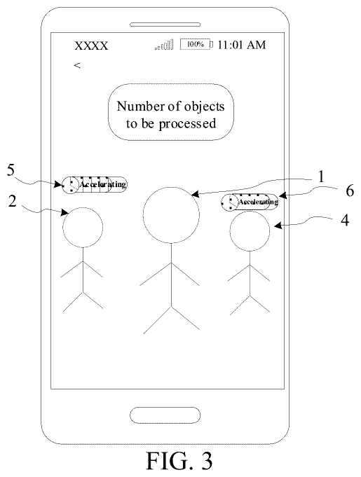

FIG. 3 is an interface schematic diagram of another processing interface provided by an embodiment of the present disclosure. As shown in FIG. 3, a marker 1 of a user and markers 2 and 4 of target objects are displayed in the processing interface. The markers 2 and 4 of a plurality of target objects may be obtained by matching in sequence. When the marker 4 of the target object is matched, the marker of the target object may be displayed in a region of the idle region 3, and the idle region 3 is not displayed. The display duration of the markers 2 and 4 of the target objects in the processing interface is a set duration, each of the markers 2 and 4 of the target objects has a corresponding duration control for displaying remaining display duration, such as a duration control 5 of the marker 2 of the target object and a duration control 6 of the marker 4 of the target object, and when the set duration is exceeded, the corresponding marker of the target object is automatically disappeared.

S120: after the target object is matched through the processing interface, the marker of the target object is displayed in a target region in the processing interface, the number of the objects to be processed is increased at an adjusted set speed, the adjusted set speed is determined based on the set speed and the level of the marker the target object, the target region is an idle region in the display region, where no marker is displayed, and the idle region in the display region is displayed in the processing interface.

The target region may refer to an idle region in the display region, where no marker is displayed, and the idle region in the display region is displayed in the processing interface. In this embodiment, the display mode of the idle region is not limited, and for example, the idle region may be a gray shadow region to represent that a current display region is an idle region where the marker is not displayed.

This embodiment does not limit which idle region is selected as the target region, any one idle region may be used as the target region, and the target region may also be selected according to the priorities of a plurality of idle regions. A setting mode for the priority of the idle region is not limited, and may be determined based on a distance away from the marker of the user and an orientation of the marker of the user. The display region includes the idle region and the target region for displaying the marker of the target object. After the marker is displayed in the target region, the target region may be not displayed in the processing interface, and only the marker of the target object is displayed in the target region.

It should be illustrated that the display duration of the marker of the target object in the target region may be a set duration, the set duration may be regarded as a duration when the marker of the target object is displayed, the set duration may be set by a system or related personnel, and this embodiment does not make any limit to it.

It may be understood that when the marker of the target object is matched in the processing interface, in the set duration, the marker of the target object may be displayed in an idle region in the display region, where no marker is displayed; when the set duration is exceeded, the marker of the target object is automatically disappeared, and then the corresponding target region is changed into the idle region in the display region, where no marker is displayed, so as to wait to display a marker of a next target object.

The number of the markers of the target objects in the processing interface may be smaller than or equal to the number of the display regions.

In this embodiment, the adjusted set speed may be regarded as a speed of increasing the number of the objects to be processed after the target object is matched, the adjusted set speed may be determined based on the set speed and the level of the marker of the target object, and in this step, the determined adjusted set speed is not limited. Exemplarily, the adjusted set speed may be determined based on the set speed and a speed value corresponding to the level of the marker of the target object, and for example, it is set that the adjusted set speed is v, the set speed is v0, and the speed value corresponding to the level of the marker of the target object is v1, and then v=v0+v1; and the adjusted set speed may also be determined based on the set speed and an acceleration value corresponding to the level of the marker of the target object. For example, it is set that the adjusted set speed is v, the set speed is v0, and the speed value corresponding to the level of the marker of the target object is a, and then v=v0 +at, where t represents an adjustment duration, the adjustment duration is a duration of adjusting the set speed, and the adjustment duration is equal to the display duration of the marker of the target object.

For example, after the target object is matched through the processing interface, the marker of the target object may be displayed in the target region in the processing interface, a state of the marker of the target object in the processing interface is not limited. Exemplarily, the marker of the target object may be displayed in a static state in the processing interface, or may be displayed in a dynamic form in the processing interface, such as a dynamic form of carrying out continuous shaking of the hand or the body under the same frequency with the marker corresponding to the object to be processed. In addition, the marker of the target object also has a corresponding level of the marker, and thus, clothes corresponding the level of the marker of the target object can be displayed in the processing interface. Different levels of the marker may correspond to different acceleration values and/or speed values. The higher the level of the marker is, the greater the corresponding acceleration value and/or speed value is.

It should be illustrated that the user may match a plurality of target objects at a time through the processing interface or repeatedly match different target objects through the processing interface, i.e., the same number of markers of the target objects with the display regions may simultaneously exist in the processing interface. One target object may be matched again after the display duration is reached. This embodiment does not make any limit to the means of matching the target object, and for example, it may be that an electronic device displaying the processing interface and an electronic device of the target object displaying a target interface are simultaneously shaken, and then the corresponding target object can be matched.

In an embodiment, the adjusted set speed is determined based on the set speed and the acceleration value corresponding to the level of the marker of the target object, different levels of the marker correspond to different acceleration values, and the adjustment duration of the set speed is a set duration.

It could be understood that different levels of the marker correspond to different acceleration values, and for example, the higher the level of the marker is, the greater the acceleration value corresponding to the level of the marker is, and for the same set speed, the higher the adjusted set speed is.

In addition, the display duration of the marker of the target object is a set duration, and thus, in the set duration, the adjusted set speed may be determined based on the set speed and the acceleration value corresponding to the level of the marker of the target object, i.e., the adjustment duration of the set speed is the set duration.

Exemplarily, in the set duration t, the adjusted set speed may be v=v0+at where v0 represents the set speed, a represents the acceleration value corresponding to the level of the marker of the target object, and when the set duration t is exceeded, the set speed is v0

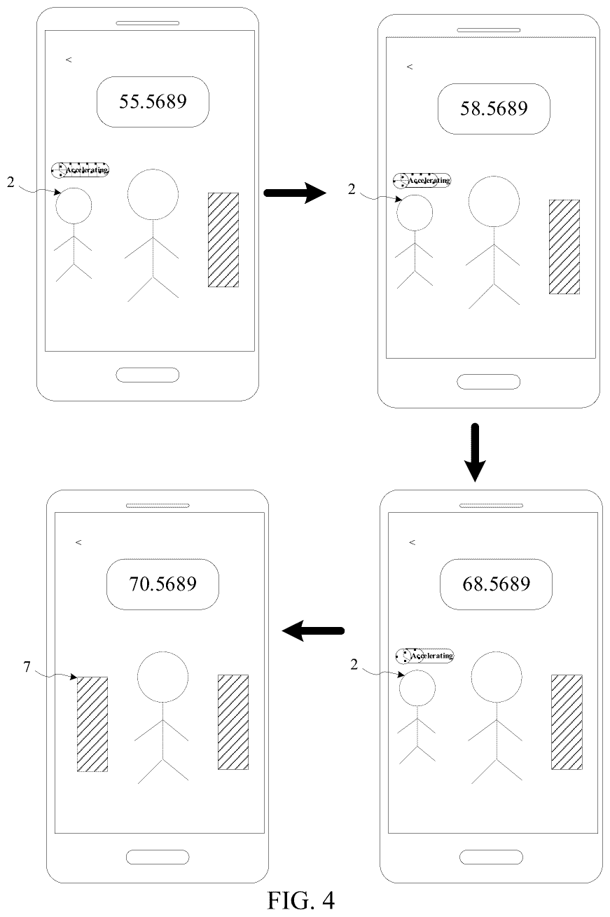

FIG. 4 is a schematic diagram of a variation of the number of the objects to be processed in one processing interface provided by an embodiment of the present disclosure. FIG. 4 is a schematic diagram of carrying out description by taking a case that the user matches out one target object from the beginning of the set duration of the marker of the target object to the end of the set duration as an example, and in FIG. 4, illustration is carried out only by taking part of frames as examples. As shown in FIG. 4, after the target object is matched through the processing interface, the marker 2 of the target object is displayed in the set duration in the target region in the processing interface, and the number of the objects to be processed is increased at the adjusted set speed; and when the set duration is exceeded, the marker 2 of the target object is automatically disappeared, and then the corresponding target region is changed into an idle region 7 in the display region, where no marker is displayed, so as to wait for a marker of a next target object.

S130: after the number of the objects to be processed in the processing interface reaches a target value, the objects to be processed are processed.

The target value may be a critical value required for processing the objects to be processed, the target value may be set by a system and related personnel, and this embodiment does not make any limit to it.

For example, through the step above, after the number of the objects to be processed in the processing interface reaches the target value, the objects to be processed may be processed. The method of processing the objects to be processed in this step is not limited. For example, the number of the objects to be processed, which corresponds to the target value, may be collected, etc.

Embodiments of the present disclosure provide an object processing method. The method is applied to an application and includes: displaying a processing interface, the number of the objects to be processed in the processing interface being increased at a set speed and the processing interface including at least one display region; after matching a target object through the processing interface, displaying a marker of the target object in a target region in the processing interface, the number of the objects to be processed being increased at an adjusted set speed, the adjusted set speed being determined based on the set speed and a level of the marker of the target object, the target region being an idle region in the display region, where no marker is displayed, and the idle region in the display region being displayed in the processing interface; and after the number of the objects to be processed in the processing interface reaches a target value, processing the objects to be processed. By utilizing the method above, after the target object is matched through the processing interface, the marker of the target object is displayed in the target region in the processing interface, and the number of the objects to be processed is increased at the adjusted set speed, so that the means of processing the objects to be processed is diversified and the visual interaction experience of the user is promoted.

On the basis of the above-mentioned embodiment, variant embodiments of the above-mentioned embodiment are proposed. It should be illustrated herein that in order to make description brief, only differences from the above-mentioned embodiment are described in the variant embodiments.

In an embodiment, the target object is matched in the following modes:
an electronic device displaying the processing interface and an electronic device of the target object displaying a target interface are simultaneously shaken; or
a shaking control of the processing interface and a shaking control of the target interface are simultaneously triggered.

The target interface may be understood as an interface where the target object carries out processing on the corresponding objects to be processed, an application corresponding to the target interface and an application corresponding to the objects to be processed may be the same, or may belong to the same application group, which are not limited herein.

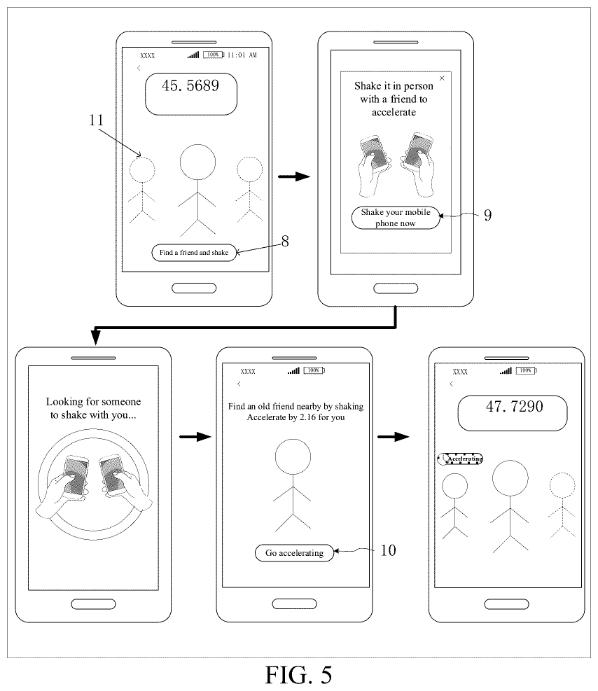

FIG. 5 is a schematic diagram of a variation of matching a target object in a processing interface provided by an embodiment of the present disclosure. In FIG. 5, description is carried out by the process that the user matches the target object in the processing interface. In FIG. 5, illustration is carried out only by taking part of frames as examples. As shown in FIG. 5, the user may click on a matching control 8 to trigger a matching interface where the target object is displayed, and then click on a shaking control 9 in the matching interface to wait for matching of the target object; and after the target object is matched, the user may click on an acceleration control 10 to enter the processing interface to carry out acceleration processing on the objects to be processed. FIG. 5 shows another style of an idle region 11, the shape of the idle region 11 is in a style of the marker of the target object and is shown in a form of dotted lines, and it is not limited herein whether the outline of the idle region 11 is formed by dotted lines or solid lines. After the target object is matched, the marker of the target object can be displayed in the target region, and the idle region 11 may be selected as the target region for displaying the marker of the target object.

In this example, after the matching control 8 and the shaking control 9 are clicked on, a matching function is started up so as to match the target object. It could be understood that the shaking control 9 may also be directly displayed in the processing interface, and after the shaking control 9 is clicked on, a shaking function is directly started up.

For example, the target interface is an interface for processing the objects to be processed in any one set application in an application group, the application group is a set formed by one or more set applications, and for the same natural person, the processing progresses of the objects to be processed in a plurality of set applications are synchronous.

The application group may be a set formed by one or more set applications, the set application may be set by related personnel, and for the same natural person, the processing progresses of the objects to be processed in a plurality of set applications are synchronous, i.e., for the same natural person, the processing progresses of the objects to be processed in a plurality of applications in the application group are shared.

Exemplarily, the application group includes an application A and an application B, the same natural person C can process the objects to be processed in both the application A and the application B, and the processing progresses of the objects to be processed in the application A and the application B are consistent.

The shaking control may be used for triggering a control for shaking an electronic device. When the shaking control is triggered, the corresponding electronic device may be shaken so as to match the target object.

For example, when the electronic device displaying the processing interface and the electronic device of the target object displaying the target interface are simultaneously shaken, or when the shaking control of the processing interface and the shaking control of the target interface are simultaneously triggered, the corresponding target object may be matched.

In an embodiment, the method further includes:
when a time interval at which the application is restarted is greater than a set threshold, adjusting the number of the objects to be processed with a first increment.

The set threshold may refer to a critical value of the time interval at which the application is restarted; and the first increment may be understood as the number of the objects to be processed directly obtained when the time interval at which the application is restarted is greater than the set threshold. The set threshold and the first increment may be respectively set by a system or related personnel, and this embodiment does not make any limit to it.

For example, when the time interval at which the application is restarted is greater than the set threshold, the number of the objects to be processed may be adjusted with the first increment. For example, it is set that the set threshold is 3 minutes and the first increment is 5, and then when the time interval at which the application is restarted is greater than 3 minutes, the number of the objects to be processed may be adjusted so as to increase the number of the current objects to be processed by 5.

In an embodiment, the method further includes:
when a set operation is received through the processing interface, adjusting the number of the objects to be processed with a second increment.

The set operation may refer to an operation set by a system, e.g., an operation triggered for completing a certain task; the second increment may be understood as the number of the objects to be processed which can be obtained when the set operation is received through the processing interface. The second increment may be respectively set by a system or related personnel, and this embodiment does not make any limit to it.

It should be understood that in the process of matching the target object through the processing interface, one or more tasks, e.g., a task of browsing a certain interface for 30 seconds, may be matched, and when the user completes the set operation corresponding to the task, the number of the objects to be processed may be adjusted with the second increment. Exemplarily, when the user does not match the target object, the user may have probability of matching out a task, and after completing the task, can obtain the reward (i.e., the second increment) for accumulating the objects to be processed.

In an embodiment, the method further includes:
when the number of the matched target objects is equal to a set number, adjusting the number of the objects to be processed with a third increment.

The set number may be regarded as a critical value of the number of the matched target objects, and the third increment may be understood as the number of the objects to be processed which can be obtained when the number of the matched target objects is equal to the set number.

For example, when the number of the matched target objects is equal to the set number, the number of the objects to be processed may be adjusted with a third increment. On this basis, by accumulating the number of the matched target objects, the number of the objects to be processed not only can be increased at the adjusted set speed, but also can be adjusted with the third increment, so that the user experience is improved.

In an embodiment, the method further includes:
when the number of the objects to be processed does not reach the target value in set time, displaying an interaction interface; and
after a confirming operation in the interaction interface is received, acquiring an interaction object corresponding to the confirming operation.

The interaction interface may be understood as an interface for acquiring the interaction object corresponding to the confirming operation, the confirming operation may refer to an operation that the user confirms to acquire the interaction object corresponding to the confirming operation, the interaction object may be regarded as an object which can be acquired when the number of the objects to be processed of the user does not reach the target value in set time, and the interaction object is not limited and for example, may be a credit, a paid special effect, and the like of a current application.

For example, when the number of the objects to be processed of the user does not reach the target value in set time, the interaction interface may be displayed; and after the confirming operation in the interaction interface is received, the interaction object corresponding to the confirming operation may be acquired.

The processing method is exemplarily described below.

Firstly, each user may have a social image (i.e., the marker, such as a tiger), and the social image is displayed in the middle of the processing interface. This tiger image has five levels (i.e., the levels of the marker) which are distinguished by different clothes worn by the tiger. With the gradual deepening of the user in an activity, the level of the tiger will be continuously increased from 1 to 5.

Then the user may match friends (i.e., the target objects) nearby in a shaking mode, and when the friends nearby are matched, social images of “little tiger” (i.e., the markers of the target object) of the friends may be displayed on a page (i.e., the processing interface) of the user and arranged on both left and right sides of the little tiger (i.e., the corresponding marker of the user) of the user. Every time when the friends nearby are matched by shaking, the tigers of the friends may proceed to a state of “working for assistance” to help the user to accelerate completion of a task so as to obtain the objects to be processed more rapidly. The more the friends matched by shaking by the user are, the more rapidly the speeds of completing the task can be overlaid.

In addition, the higher the tiger level of the friend matched by shaking by the user is, the higher the “working for assistance” speed (i.e., the adjusted set speed) may be, and thus, the more deeply the user participates in the activity, the greater the number of people matched by shaking is, and the higher the speed of completing processing will be.

By the description on embodiments above, it can be found that according to the embodiments of the present disclosure, accounts of the user for logging in a plurality of APPs may be induced into the same account group by information such as a device identifier, a cell-phone number, etc., it is considered that a plurality of accounts in the same account group all belong to the same natural person, and a plurality of APPs form the application group; and the activity progresses of the same natural person in the plurality of APPs are broken through, and when logging in the random APP, the user can inherit and synchronize existing accumulation progress (i.e., the processing progress of the objects to be processed). on this basis, breakthrough of the accounts of the user is implemented, the play space for the user to processing the objects to be processed is improved, and the completion difficulty is reduced.

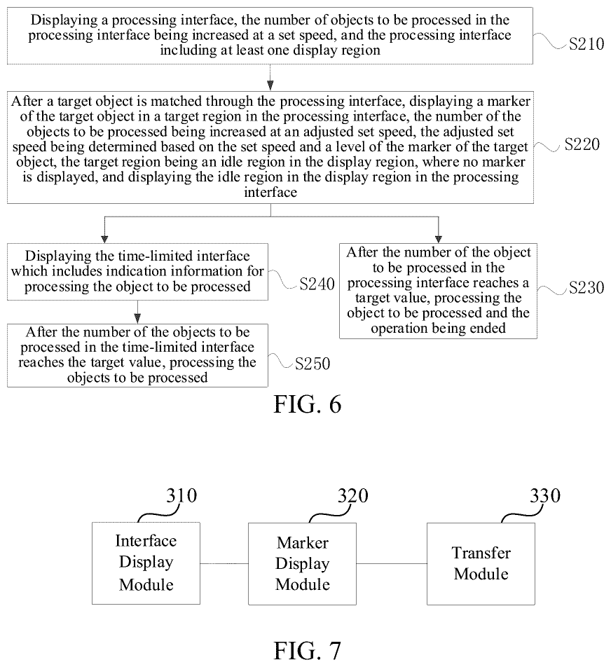

FIG. 6 is a flow schematic diagram of an object processing method provided by another embodiment of the present disclosure. The present embodiment is refined on the basis of a plurality of example solutions in the above embodiments. In the present embodiment, the object processing method may further include: displaying a time-limited interface, the time-limited interface including indication information for processing the objects to be processed; and after the number of the object to be processed in the time-limited interface reaches the target value, processing the object to be processed.

The content which is not illustrated in detail in this embodiment may refer to the above embodiment.

As shown in FIG. 6, an object processing method provided by another embodiment of the present disclosure includes the following steps.

At S210, a processing interface is displayed, the number of objects to be processed in the processing interface is increased at a set speed, and the processing interface includes at least one display region.

At S220, after a target object is matched through the processing interface, a marker of the target object is displayed in a target region in the processing interface, the number of the objects to be processed is increased at an adjusted set speed, the adjusted set speed is determined based on the set speed and a level of the marker of the target object, the target region is an idle region in the display region, where no marker is displayed, and the idle region in the display region is displayed in the processing interface.

In this step, when the target object is matched through the processing interface, the marker of the target object may be displayed in the target region in the processing interface. Meanwhile, the number of the objects to be processed is increased at the adjusted set speed. In the process that a user matches the target object through the processing interface, a time-limited interface may be displayed. In the time-limited interface, the user can select whether to carry out processing of an operation indicated by the indication information of the objects to be processed according to personal willingness. After the number of the objects to be processed in the time-limited interface reaches a target value, the user can directly process the objects to be processed.

At S230: after the number of the objects to be processed in the processing interface reaches a target value, the objects to be processed are processed and the operation is ended.

At S240, the time-limited interface which includes indication information for processing the objects to be processed is displayed.

The time-limited interface may represent an interface where the user can select whether to carry out processing of the indication information of the objects to be processed. For example, a time-limited control may be included in the time-limited interface, and the time-limited control may be a control that the user confirms to select to carry out processing of the indication information of the objects to be processed; a closing control may also be included in the time-limited interface, and the closing control may represent a control that the user confirms not to select to carry out processing of the indication information of the objects to be processed; the indication information for processing the objects to be processed may also be included in the time-limited interface, the indication information may be information that indicates to process the objects to be processed so as to definitely inform a time-limited operation which needs to be completed by the user, e.g., interactive live broadcasting for 10 minutes, etc.

This embodiment does not make any limit to the timing when the time-limited interface is displayed, and for example, the time-limited interface may be randomly displayed or may be displayed when the user complete a hidden operation. The hidden operation may be understood as an operation hidden in a system and unknown for the user, and the hidden operation may be set in advance by the system or related personnel, which is not limited herein.

At S250, after the number of the objects to be processed in the time-limited interface reaches the target value, the objects to be processed are processed.

For example, after the number of the objects to be processed in the time-limited interface reaches the target value, the objects to be processed may be processed so as to complete the operation.

Exemplarily, in this embodiment, the time-limited interface may be arranged so as to set a “get-it-straight” task and definitely inform that the user can directly take away all accumulated virtual resources (i.e., the target value) when completing the specific task (i.e., the indication information for processing the objects to be processed).

According to the object processing method provided by embodiments of the present disclosure, by arranging the time-limited interface, the viscosity of the user in the process of processing the objects to be processed can be increased, and meanwhile, after the number of the objects to be processed in the time-limited interface reaches the target value, processing on the objects to be processed can be implemented, so that the processing difficulty is reduced for the user, the means of processing the objects to be processed is diversified, and the interaction experience of the user is promoted.

FIG. 7 is a structural schematic diagram of an object processing apparatus provided by an embodiment of the present disclosure. The apparatus may be applicable to a case of processing an object, the apparatus may be implemented by software and/or hardware and generally integrated on an electronic device.

As shown in FIG. 7, the apparatus includes:
an interface display module 310, configured to display a processing interface, where the number of objects to be processed in the processing interface is increased at a set speed and the processing interface includes at least one display region;
a marker display module 320, configured to, in response to determining that a target object is matched through the processing interface, display a marker of the target object in a target region in the processing interface, and increase the number of the objects to be processed at an adjusted set speed, wherein the adjusted set speed is determined based on the set speed and a level of the marker of the target object, the target region is an idle region in the display region, where no marker is displayed, and the idle region in the display region is displayed in the processing interface; and
a transfer module 330, configured to in response to determining that the number of the objects to be processed in the processing interface reaches a target value, process the objects to be processed.

In this embodiment, according to the apparatus, the processing interface is displayed through the interface display module 310, the number of the objects to be processed in the processing interface is increased at the set speed, and the processing interface includes at least one display region; after a target object is matched through the processing interface, the marker of the target object is displayed in the target region in the processing interface through the marker display module 320, the number of the objects to be processed is increased at the adjusted set speed, the adjusted set speed is determined based on the set speed and the level of the marker of the target object, the target region is an idle region in the display region, where no marker is displayed, and the idle region in the display region is displayed in the processing interface; and after the number of the objects to be processed in the processing interface reaches the target value, the objects to be processed are processed through the transfer module 330. By utilizing the apparatus, after the target object is matched through the processing interface, the marker of the target object is displayed in the target region in the processing interface, and the number of the objects to be processed is increased at the adjusted set speed, so that the visual interaction experience of the user is promoted and the interestingness of an object processing method is improved.

For example, the processing interface includes at least one display region, the marker of the target object is displayed in the target region, a display duration of the marker of the target object in the target region is a set duration, the target region is an idle region in the display region, where no marker is displayed, and the idle region in the display region is displayed in the processing interface.

For example, the adjusted set speed is determined based on the set speed and an acceleration value corresponding to the level of the marker of the target object, different levels of the marker correspond to different acceleration values, and an adjustment duration of the set speed is a set duration.

For example, a marker of a user is displayed in the processing interface, a level of the marker of the user is increased with the increase of a completion degree of processing the objects to be processed, the level of the marker of the target object is increased with the increase of a completion degree of processing corresponding objects to be processed by the target object, and markers of different levels have different clothes.

For example, the marker display module 320 includes: a matching unit which is configured to match the target object in the following modes:
an electronic device displaying the processing interface and an electronic device of the target object displaying a target interface are simultaneously shaken; or
a shaking control of the processing interface and a shaking control of the target interface are simultaneously triggered.

For example, the target interface is an interface for processing the objects to be processed in any one set application in an application group, the application group is a set formed by one or more set applications, and for the same natural person, the processing progresses of the objects to be processed in a plurality of set applications are synchronous.

For example, the object processing apparatus further includes a restart module which is configured to:
when a time interval at which the application is restarted is greater than a set threshold, adjust the number of the objects to be processed with a first increment.

For example, the object processing apparatus further includes a target task matching module which is configured to:
when a set operation is received through the processing interface, adjust the number of the objects to be processed with a second increment.

For example, the object processing apparatus further includes an opportunity acquisition module which is configured to:
when the number of the matched target objects is equal to a set number, adjust the number of the objects to be processed with a third increment.

For example, the object processing apparatus further includes a time-limited target completion module which is configured to:

display a time-limited interface which includes indication information for processing the objects to be processed; and
after the number of the objects to be processed in the time-limited interface reaches the target value, process the objects to be processed.

For example, the object processing apparatus further includes an interaction object acquisition module which is configured to:
when the number of the objects to be processed does not reach the target value in set time, display an interaction interface; and
after a confirming operation in the interaction interface is received, acquire an interaction object corresponding to the confirming operation.

The above-mentioned object processing apparatus may perform the object processing method provided by any one embodiment of the present disclosure, and has corresponding function modules for performing the method and beneficial effects.

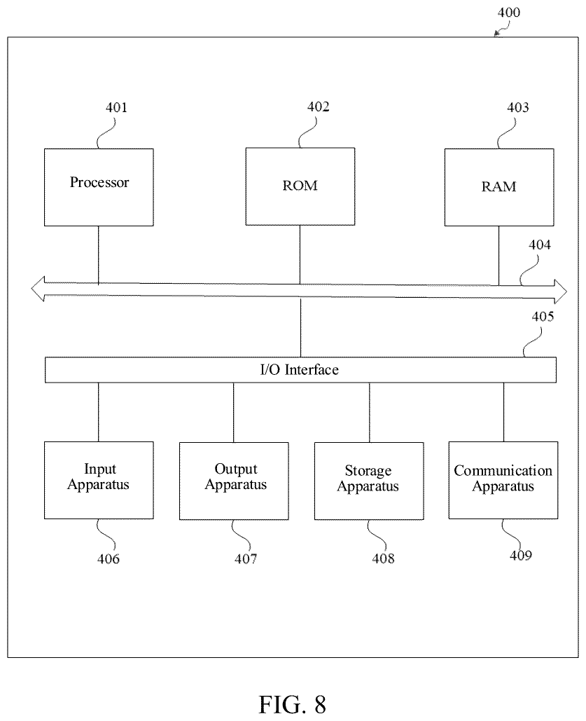

FIG. 8 is a structural schematic diagram of an electronic device provided by an embodiment of the present disclosure. FIG. 8 shows the structure schematic diagram suitable for achieving the electronic device 400 in the embodiment of the present disclosure. The electronic device 400 in the embodiment of the present disclosure may include but not be limited to a mobile terminal such as a mobile phone, a notebook computer, a digital broadcasting receiver, a personal digital assistant (PDA), a portable android device (PAD), a portable multimedia player (PMP), a vehicle terminal (such as a vehicle navigation terminal), and a fixed terminal such as a digital television (TV) and a desktop computer. The electronic device 400 shown in FIG. 8 is only an example and should not impose any limitations on the functions and use scopes of the embodiments of the present disclosure.

As shown in FIG. 8, the electronic device 400 may include a processor (such as a central processing unit, and a graphics processor) 401, it may execute a plurality appropriate actions and processes according to a program stored in a read-only memory (ROM) 402 or a program loaded from a storage apparatus 408 to a random access memory (RAM) 403. One or more processors 401 implement the method provided by the present disclosure. In RAM 403, a plurality of programs and data required for operations of the electronic device 400 are also stored. The processor 401, ROM 402, and RAM 403 are connected to each other by a bus 404. An input/output (I/O) interface 405 is also connected to the bus 404.

Typically, the following apparatuses may be connected to the I/O interface 405: an input apparatus 406 such as a touch screen, a touchpad, a keyboard, a mouse, a camera, a microphone, an accelerometer, and a gyroscope; an output apparatus 407 such as a liquid crystal display (LCD), a loudspeaker, and a vibrator; a storage apparatus 408 such as a magnetic tape, and a hard disk drive; and a communication apparatus 409. The communication apparatus 409 may allow the electronic device 400 to wireless-communicate or wire-communicate with other devices so as to exchange data. Although FIG. 8 shows the electronic device 400 with a plurality of apparatuses, it is not required to implement or possess all the apparatuses shown. Alternatively, it may implement or possess the more or less apparatuses.

According to the embodiment of the present disclosure, the process described above with reference to the flowchart may be achieved as a computer software program. For example, an embodiment of the present disclosure includes a computer program product, it includes a computer program carried on a computer-readable medium, and the computer program includes program codes for executing the method shown in the flowchart. In such an embodiment, the computer program may be downloaded and installed from the network by the communication apparatus 409, or installed from the storage apparatus 408, or installed from ROM 402. When the computer program is executed by the processor 401, the above functions defined in the method in the embodiments of the present disclosure are executed.

It should be noted that the above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More examples of the computer-readable storage medium may include but not be limited to: an electric connector with one or more wires, a portable computer magnetic disk, a hard disk drive, a RAM, a ROM, an erasable programmable read-only memory (EPROM or flash memory), an optical fiber, a compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt a plurality of forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above. The computer-readable storage medium may be a non-transitory computer-readable storage medium.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the electronic device 400 described above, or may exist alone without being assembled into the electronic device 400.

The above-mentioned computer-readable medium stores one or more computer programs, and when the one or more programs are executed by a processor, the following method is implemented. The above-mentioned computer-readable medium carries one or more programs which, when executed by the electronic device, cause the electronic device 400. The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including local area network (LAN) or wide area network (WAN), or may be connected to an external computer (such as connected by using an internet service provider through the Internet).

The flowcharts and the block diagrams in the drawings show possibly achieved system architectures, functions, and operations of systems, methods, and computer program products according to a plurality of embodiments of the present disclosure. At this point, each box in the flowchart or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flowchart, as well as combinations of the boxes in the block diagram and/or the flowchart, may be achieved by using a dedicated hardware-based system that performs the specified function or operation, or may be achieved by using combinations of dedicated hardware and computer instructions.

The involved modules described in the embodiments of the present disclosure may be achieved by a mode of software, or may be achieved by a mode of hardware. The name of the module does not constitute a limitation for the module itself in a case.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard part (ASSP), a system on chip (SOC), a complex programmable logic device (CPLD) and the like.

In the context of the present disclosure, the machine-readable medium may be a visible medium, and it may contain or store a program for use by or in combination with an instruction executive system, apparatus, or device. The machine-readable medium may be a machine-readable signal medium or a machine-readable storage medium. The machine-readable medium may include but not limited to an electronic, magnetic, optical, electromagnetic, infrared, or semiconductor system, apparatus, or device, or any suitable combinations of the above. More specific examples of the machine-readable storage medium may include an electric connector based on one or more wires, a portable computer disk, a hard disk drive, RAM, ROM, EPROM (or a flash memory), an optical fiber, CD-ROM, an optical storage device, a magnetic storage device, or any suitable combinations of the above.

According to one or more embodiments of the present disclosure, Example 1 provides an object processing method, being applied to an application and including:
displaying a processing interface, wherein a number of objects to be processed in the processing interface is increased at a set speed and the processing interface includes at least one display region;
in response to determining that a target object is matched through the processing interface, displaying a marker of the target object in a target region in the processing interface, the number of the objects to be processed being increased at an adjusted set speed, wherein the adjusted set speed is determined based on the set speed and a level of the marker of the target object, the target region is an idle region in the display region, where no marker is displayed, and the idle region in the display region is displayed in the processing interface; and
in response to determining that the number of the objects to be processed in the processing interface reaches a target value, processing the objects to be processed.

According to one or more embodiments of the present disclosure, Example 2 provides the method according to Example 1, wherein
the adjusted set speed is determined based on the set speed and an acceleration value corresponding to the level of the marker of the target object, different levels of the marker correspond to different acceleration values, and an adjustment duration of the set speed is a set duration.

According to one or more embodiments of the present disclosure, Example 3 provides the method according to Example 1, wherein
a marker of a user is displayed in the processing interface, a level of the marker of the user is increased with an increase of a completion degree of processing the objects to be processed, the level of the marker of the target object is increased with an increase of a completion degree of processing corresponding objects to be processed by the target object, and markers of different levels have different clothes.

According to one or more embodiments of the present disclosure, Example 4 provides the method according to Example 1, wherein the target object is matched in following modes:
an electronic device displaying the processing interface and an electronic device of the target object displaying a target interface are simultaneously shaken; or
a shaking control of the processing interface and a shaking control of the target interface are simultaneously triggered.

According to one or more embodiments of the present disclosure, Example 5 provides the method according to Example 4, wherein
the target interface is an interface for processing the objects to be processed in any one set application in an application group, the application group is a set formed by at least one set applications, and for a same natural person, processing progresses of the objects to be processed in a plurality of set applications are synchronous.

According to one or more embodiments of the present disclosure, Example 6 provides the method according to Example 1, and the method further includes:
in response to determining that a time interval at which the application is restarted is greater than a set threshold, adjusting the number of the objects to be processed with a first increment.

According to one or more embodiments of the present disclosure, Example 7 provides the method according to Example 1, and the method further includes:
in response to determining that a set operation is received through the processing interface, adjusting the number of the objects to be processed with a second increment.

According to one or more embodiments of the present disclosure, Example 8 provides the method according to Example 1, and the method further includes:
in response to determining that a number of matched target objects is equal to a set number, adjusting the number of the objects to be processed with a third increment.

According to one or more embodiments of the present disclosure, Example 9 provides the method according to Example 1, and the method further includes:
displaying a time-limited interface, the time-limited interface including indication information for processing the objects to be processed; and
in response to determining that the number of the objects to be processed in the time-limited interface reaches the target value, processing the objects to be processed.

According to one or more embodiments of the present disclosure, Example 10 provides the method according to Example 1, and the method further includes:
in response to determining that the number of the objects to be processed does not reach the target value in set time, displaying an interaction interface; and
in response to determining that a confirming operation in the interaction interface is received, acquiring an interaction object corresponding to the confirming operation.

According to one or more embodiments of the present disclosure, Example 11 provides an object processing apparatus, including:
an interface display module, configured to display a processing interface, where a number of objects to be processed in the processing interface is increased at a set speed and the processing interface includes at least one display region;
a marker display module, configured to, in response to determining that a target object is matched through the processing interface, display a marker of the target object in a target region in the processing interface, and increase the number of the objects to be processed at an adjusted set speed, wherein the adjusted set speed is determined based on the set speed and a level of the marker of the target object, the target region is an idle region in the display region, where no marker is displayed, and the idle region in the display region is displayed in the processing interface; and
a transfer module, configured to in response to determining that the number of the objects to be processed in the processing interface reaches a target value, process the objects to be processed.

According to one or more embodiments of the present disclosure, Example 12 provides an electronic device, including:
one or more processors;
a storage apparatus, configured to store one or more programs,
wherein the one or more programs are executed by the one or more processors, causing the one or more processors to implement the method according to any one of examples 1-10.

According to one or more embodiments of the present disclosure, Example 13 provides a computer-readable medium, storing computer programs, wherein the computer programs upon being executed by a processor, implement the method according to any one of examples 1-10.

In addition, while the plurality of operations have been described in a particular order, it shall not be construed as requiring that such operations are performed in the stated specific order or sequence. Under certain circumstances, multitasking and parallel processing may be advantageous. Similarly, while the plurality of specific implementation details are included in the above discussions, these shall not be construed as limitations to the present disclosure. Some features described in the context of a separate embodiment may also be combined in a single embodiment. Rather, the plurality of features described in the context of a single embodiment may also be implemented separately or in any appropriate sub-combination in a plurality of embodiments.

What is claimed is:

1. An object processing method comprising:
displaying a processing interface, wherein a number of objects to be processed in the processing interface is increased at a set speed and the processing interface comprises at least one display region;
in response to determining that a target object is matched through the processing interface, displaying a marker of the target object in a target region in the processing interface, the number of the objects to be processed being increased at an adjusted set speed, wherein the adjusted set speed is determined based on the set speed and a level of the marker of the target object, the target region is an idle region in the display region, where no marker is displayed, and the idle region in the display region is displayed in the processing interface; and
in response to determining that the number of the objects to be processed in the processing interface reaches a target value, processing the objects to be processed.

2. The method according to claim 1, wherein the adjusted set speed is determined based on the set speed and an acceleration value corresponding to the level of the marker of the target object, different levels of the marker correspond to different acceleration values, and an adjustment duration of the set speed is a set duration.

3. The method according to claim 1, wherein a marker of a user is displayed in the processing interface, a level of the marker of the user is increased with an increase of a completion degree of processing the objects to be processed, the level of the marker of the target object is increased with an increase of a completion degree of processing corresponding objects to be processed by the target object, and markers of different levels have different clothes.

4. The method according to claim 1, wherein the target object is matched in following modes:
an electronic device displaying the processing interface and an electronic device of the target object displaying a target interface are simultaneously shaken; or
a shaking control of the processing interface and a shaking control of the target interface are simultaneously triggered.

5. The method according to claim 4, wherein the target interface is an interface for processing the objects to be processed in any one set application in an application group, the application group is a set formed by at least one set applications, and for a same natural person, processing progresses of the objects to be processed in a plurality of set applications are synchronous.

6. The method according to claim 1, further comprising:
in response to determining that a time interval at which the application is restarted is greater than a set threshold, adjusting the number of the objects to be processed with a first increment.

7. The method according to claim 1, further comprising:
in response to determining that a set operation is received through the processing interface, adjusting the number of the objects to be processed with a second increment.

8. The method according to claim 1, further comprising:
in response to determining that a number of matched target objects is equal to a set number, adjusting the number of the objects to be processed with a third increment.

9. The method according to claim 1, further comprising:
displaying a time-limited interface, the time-limited interface comprising indication information for processing the objects to be processed; and
in response to determining that the number of the objects to be processed in the time-limited interface reaches the target value, processing the objects to be processed.

10. The method according to claim 1, further comprising:
in response to determining that the number of the objects to be processed does not reach the target value in set time, displaying an interaction interface; and
in response to determining that a confirming operation in the interaction interface is received, acquiring an interaction object corresponding to the confirming operation.

11. (canceled)

12. An electronic device, comprising:
one or more processors;
a storage apparatus, configured to store one or more programs,
wherein the one or more programs are executed by the one or more processors, causing the one or more processors to implement an object processing method, the method is applied to an application and comprises:
displaying a processing interface, wherein a number of objects to be processed in the processing interface is increased at a set speed and the processing interface comprises at least one display region;
in response to determining that a target object is matched through the processing interface, displaying a marker of the target object in a target region in the processing interface, the number of the objects to be processed being increased at an adjusted set speed, wherein the adjusted set speed is determined based on the set speed and a level of the marker of the target object, the target region is an idle region in the display region, where no marker is displayed, and the idle region in the display region is displayed in the processing interface; and
in response to determining that the number of the objects to be processed in the processing interface reaches a target value, processing the objects to be processed.

13. A non-transitory computer-readable medium, storing computer programs, wherein the computer programs upon being executed by a processor, implement an object processing method, the method is applied to an application and comprises:
displaying a processing interface, wherein a number of objects to be processed in the processing interface is increased at a set speed and the processing interface comprises at least one display region;
in response to determining that a target object is matched through the processing interface, displaying a marker of the target object in a target region in the processing interface, the number of the objects to be processed being increased at an adjusted set speed, wherein the adjusted set speed is determined based on the set speed and a level of the marker of the target object, the target region is an idle region in the display region, where no marker is displayed, and the idle region in the display region is displayed in the processing interface; and
in response to determining that the number of the objects to be processed in the processing interface reaches a target value, processing the objects to be processed.

14. The electronic device according to claim 12, wherein the adjusted set speed is determined based on the set speed and an acceleration value corresponding to the level of the marker of the target object, different levels of the marker correspond to different acceleration values, and an adjustment duration of the set speed is a set duration.

15. The electronic device according to claim 12, wherein a marker of a user is displayed in the processing interface, a level of the marker of the user is increased with an increase of a completion degree of processing the objects to be processed, the level of the marker of the target object is increased with an increase of a completion degree of processing corresponding objects to be processed by the target object, and markers of different levels have different clothes.

16. The electronic device according to claim 12, wherein the target object is matched in following modes:
an electronic device displaying the processing interface and an electronic device of the target object displaying a target interface are simultaneously shaken; or
a shaking control of the processing interface and a shaking control of the target interface are simultaneously triggered.

17. The electronic device according to claim 16, wherein the target interface is an interface for processing the objects to be processed in any one set application in an application group, the application group is a set formed by at least one set applications, and for a same natural person, processing progresses of the objects to be processed in a plurality of set applications are synchronous.

18. The electronic device according to claim 12, wherein the method further comprises:
in response to determining that a time interval at which the application is restarted is greater than a set threshold, adjusting the number of the objects to be processed with a first increment.

19. The electronic device according to claim 12, wherein the method further comprises:
in response to determining that a set operation is received through the processing interface, adjusting the number of the objects to be processed with a second increment.

20. The electronic device according to claim 12, wherein the method further comprises:
in response to determining that a number of matched target objects is equal to a set number, adjusting the number of the objects to be processed with a third increment.

21. The electronic device according to claim 12, wherein the method further comprises:
displaying a time-limited interface, the time-limited interface comprising indication information for processing the objects to be processed; and
in response to determining that the number of the objects to be processed in the time-limited interface reaches the target value, processing the objects to be processed.
